(19) United States
(12) Patent Application Publication
(10) Pub. No.: US 2024/0142646 A1
(43) Pub. Date: May 2, 2024

(54) DEVICES, SYSTEMS, AND METHODS PROVIDING EARTHQUAKE INFORMATION WITH DISTRIBUTED FIBER-OPTIC SENSING

(71) Applicant: FIBER SENSE LIMITED, Mosman, NSW (AU)

(72) Inventor: Nathaniel J. LINDSEY, Oakland, CA (US)

(21) Appl. No.: 18/280,652

(22) PCT Filed: Mar. 7, 2022
(86) PCT No.: PCT/US2022/019113

§ 371 Date: Sep. 6, 2023

Related U.S. Application Data
(60) Provisional application No. 63/157,789, filed on Mar. 7, 2021.

(51) Int. Cl. G01V 1/01; G01V 1/22

(52) U.S. Cl. CPC G01V 1/01; G01V 1/226

(57) ABSTRACT

A method of determining a peak ground acceleration includes providing a DFOS instrument connected to at least one optical fiber and recording DFOS data with the DFOS instrument. The DFOS data includes strain data along the at least one optical fiber. The method also includes converting the strain data into complex Fourier coefficients, scaling the complex Fourier coefficients, applying an inverse transform to the scaled Fourier coefficients, and selecting a maximum value from an output of the inverse transform to identify the peak ground acceleration for a position along the at least one optical fiber.

### CROSS-REFERENCE TO RELATED APPLICATIONS

This application claims the benefit of U.S. Provisional Application No. 63/157,789 filed Mar. 7, 2021, which is incorporated herein by reference in its entirety.

### BACKGROUND

A decade after the 11 Mar. 2011 Japanese Tohoku-Oki M9.0 megathrust earthquakes and the 2011 Christchurch, New Zealand earthquakes, seismic events remain a pressing concern for densely populated cities worldwide. Earthquakes pose a number of risks to both human life and infrastructure. Catastrophic structural collapse during primary ground motions from earthquakes is often followed up in deadly succession by secondary hazards like tsunami, landslides, liquefaction and additional aftershocks. These are often more deadly than the initial shaking. Major economic losses related to infrastructure damages pose unsustainable burdens on home and building owners, but also private and state-owned financial institutions that offer seismic insurance policies.

Conventionally, a sparse network of seismometers is used to quantify the degree of ground motion from earthquakes. A few seismometers often in the region surrounding a city or far from where people live and work are commonly generalized to the entire city. In reality, the ground motion varies dramatically across a city depending on local geology, sediment thickness and soil conditions, as well as the directionality of the seismic waves. The present information about earthquake ground motions obtained from the sparse seismometer network is insufficient to provide the desired resolution of information on an address-by-address basis.

Because the information from seismometers after major earthquakes is incomplete, engineers and seismologists are deployed following major earthquakes to survey addresses to determine the degree of damage, often looking for visual evidence of cracks in walls or other damage inside or outside the building. These surveys can be very inefficient, often delaying transportation systems or critical infrastructure up to a day or more to get back online. Many buildings are never surveyed, which creates a scenario where the burden of proof is placed on the building owner to document damages themselves.

Furthermore, while this system is designed to assess major earthquakes (e.g., magnitudes M>6.5-7.0), when light to moderate shaking occurs in a repeated fashion as a result of many frequent relatively smaller magnitude events (M2.0-M6.5), it then becomes difficult to understand the long-term structural integrity of the building, or establish causal linkage between an earthquake claim and the damage from an insurance standpoint.

### SUMMARY

Embodiments of the present disclosure provide methods, systems, and devices that enable analysis of the effects of earthquakes, such as the degree of ground motion amplitude, the region of elevated risk, and the presence of secondary natural hazards such as tsunami and liquefaction.

One skilled in the art would appreciate that when it comes to earthquake seismology, detection is not the primary concern today. There are a multitude of ways to detect that an earthquake has occurred, for example, one could use an external earthquake service from a mobile device to confirm that an earthquake has occurred. In the moments after a damaging earthquake occurs, the most valuable information is not the seismic detection but rather the seismic impact. In particular, the embodiments provide methods, systems and devices to characterize the type, style and degree of earthquake ground motion, and how said ground motion affected buildings and other infrastructure. From this perspective, the present embodiments present methods, devices, and systems to improve forecasting of seismic risk at a spatial resolution that allows assessment of individual addresses (such as a building or a designated area) in populated areas—so called, “peak ground acceleration by address”.

In embodiments, a methods, devices, and systems use Distributed Fiber Optic Sensing (DFOS) measurements made along optical fibers (such as the telecommunications fiber infrastructure) with a high resolution (e.g., single meter resolution) to provide quantitative information about potential building damage, structural integrity, liquefaction, potential for secondary hazards, and economic damage caused by seismic energy.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Some of the figures may have been simplified by the omission of selected features for the purpose of more clearly showing other underlying features. Such omissions of elements in some figures are not necessarily indicative of the presence or absence of particular elements in any of the exemplary embodiments, except as may be explicitly disclosed in the corresponding written description.

FIG. 1 illustrates an example of a DFOS instrument sending and receiving laser light according to embodiments of the disclosed subject matter.

FIG. 2 illustrates a non-limiting example of a method of calculating peak ground acceleration according to embodiments of the disclosed subject matter.

FIG. 3 illustrates a non-limiting example of a method of calculating peak ground acceleration based on regional seismic velocity model according to embodiments of the disclosed subject matter.

FIGS. 4A-B illustrate non-limiting examples of a methods of quantifying effects of ground motion according to embodiments of the disclosed subject matter.

FIG. 5 illustrates an earthquake record section from a DFOS recording performed according to embodiments of the disclosed subject matter.

FIG. 6 illustrates exemplary regional coverage at a number of azimuths and distances calculated in accordance with embodiments of the disclosed subject matter.

FIGS. 7A-F illustrate measurements of DFOS data made in accordance with embodiments of the disclosed subject matter.

FIG. 8 illustrates peak ground acceleration calculated for a portion of a city in accordance with embodiments of the disclosed subject matter.

FIG. 9 illustrates results of aggregating results obtained in accordance with embodiments of the disclosed subject matter.

FIG. 10 illustrates a method of self-assessment of earthquake induced effects according to embodiments of the disclosed subject matter.

### DETAILED DESCRIPTION

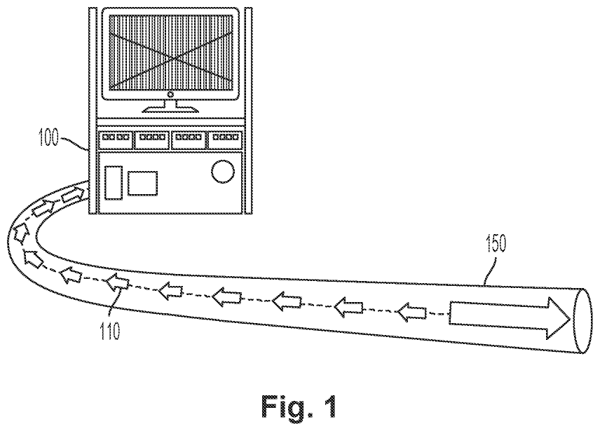

Referring to FIG. 1, A DFOS instrument 100 shines a light into an optical fiber 150 and records the energy 110 returning as a function of time. The light can be any kind, including a simple pulse, chirped pulse, or continuous wave. In embodiments, the light is laser light. In further embodiments the laser light is in the infrared or near infrared frequency range. The energy returning from the optical fiber sensing path may have been Rayleigh scattered as a result of the optical scattering properties along the length of the optical fiber, or the returning energy may have been caused by some Brilluoin or Raman transitions from the incident wavelength. The returning light can be analyzed optically, digitally, or both. The output of this process is a dataset, referred to here as the DFOS data or DFOS recording, which contains values about the state of the optical fiber for a particular time sample at all sensor positions in the fiber.

In embodiments, telecommunication receiver statistics themselves are collected as input date for DFOS, without a dedicated instrument at one end, to extract information related to the fiber state, such as a property of polarization or time of flight from one end to the other which might carry information about the time-rate of change of fiber length, or state of stress or strain of the fiber at a point or over its length. It will be understood that strain includes geodetic strain, which can be measured by the geodetic strain response. After an earthquake, the surface of the earth immediately around the epicenter of the earthquake moves, possibly laterally, or up and down across the fault, among others. This movement is referred to as geodetic strain.

In an embodiment, the DFOS instrument can be an interrogator unit (“IU”) such as a unit for distributed acoustic sensing described in WO 2018/045433 A1, which is incorporated by reference in its entirety herein.

In some cases of DFOS there is not a physical fixed length sensor position. In principle, the gauge length is the distance along the optical fiber over which one DFOS value is sensitive. For example, in one type of pulsed Rayleigh-based DFOS the gauge length may be 10 m and the recorded data could be strain; in this case, the 10 m gauge length is the “reference length” over which displacements cause the resulting strain. The gauge length can affect many aspects of the measurement including the quality of the measurement, the gain of the measurement, the finest spatial size that can be analyzed without spatial aliasing, and the recorded DFOS data volume. The gauge length can be set in hardware and/or software. If the gauge length is established in software it may be possible to record DFOS data at multiple gauge lengths.

The DFOS measurement is sensitive to the motion/deformation of the optical fiber, and hence the motion/deformation of the optical fiber's surroundings. For example, during an earthquake the soil will undergo compression and rarefaction as the seismic waves propagate through the near surface, and this motion will be transferred to the optical fiber.

The DFOS measurement can be made wherever a continuous optical fiber exists and can be connected at one end to a DFOS instrument. The fiber can be laid in any orientation, or even wrapped around a central cylinder in a helical fashion (e.g., wrapped around pylons of a bridge or wrapped around a building's foundation) to introduce more than one component of motion/deformation to each gauge length of the DFOS measurement. Existing optical fiber laid for a different purpose can be utilized for the DFOS measurement. Multiple fibers can be joined in series and used for DFOS with one instrument, or multiple DFOS channels (analyzed with the same or separate DFOS instruments) can be used to record DFOS data within the same vicinity.

DFOS measurements made along the fiber path provide quantitative information about the displacement, velocity, acceleration, and/or strain resulting from the ground motion of the earthquake, and therefore provide data the directly quantify the hazard posed to building damage, liquefaction, structural integrity.

In various embodiments, DFOS measurements are made before earthquake waves have reached a particular location but (e.g., seconds just before), during ground shaking, and after ground shaking. It will be understood that the particular location may be a location in a population area, and the spatial resolution may be on the order of meters (e.g., 1 meter) so that a specific building may be identified.

Earthquakes often occur some distance away from populations and infrastructure. For example, most major earthquakes occurring offshore Japan and New Zealand and British Columbia, Canada have been located 100 km or more away from coastal cities. In embodiments, long fibers (e.g., with lengths measured in hundreds of kilometers) that are deployed offshore and onshore for telecommunications can also be used to detect these remote earthquakes at any point along the fiber using the light signals traveling at speed of light inside the fiber.

In embodiments, a DFOS instrument is located in an urban data center onshore and connected to a length (e.g., 100 km) offshore fiber path. If an earthquake occurs 100 km offshore at the ocean end of the fiber, the use of DFOS measurements can present a scenario where the use of DFOS provides for earthquake early warning. In this example, the ocean fiber is deformed by the P-wave (primary wave) that travels fastest through the Earth away from the earthquake's location, and this deformation of the ocean fiber is detected and quantified using DFOS measurements. If the optical fiber sensing length is 100 km long, then this will allow the system to issue an alert with 16.7 seconds of earthquake warning to the city before the P-wave arrives at the city (P-wave speed of 6 km/s is assumed). The most damaging Rayleigh wave or surface wave arrivals are slightly delayed due to their relatively slower speed compared to the P-wave, and so up to 50 seconds of warning may be possible to the populated area with this approach (Rayleigh wave speed of 2 km/s assumed). Thus, it will be understood that by employing DFOS with existing, or newly installed, fiber cables that extend to or past an earthquake epicenter, it is possible to detect the occurrence of the earthquake and provide a warning at a population center before P-wave and surface waves from the earthquake reach the city. It will be further understood that direct observations of geotechnical conditions at the epicenter location (that are increasingly likely with large scale deployments of DFOS over telecommunications fiber cables) is able to provide high density geotechnical data that can be used to forecast the likelihood of an earthquake megathrust event before it occurs.

In embodiments, DFOS measurements are used to provide information about the style, direction, and/or the amplitude and duration of ground shaking (e.g., in terms of peak ground acceleration or PGA). It would be clear to one of ordinary skill in the art of seismology and earthquake science or signal processing that the measurement amplitude obtained in the proposed method would be maximal during the timing of earthquakes based on the history of earthquake recording in urban areas. Hence, it is possible to utilize DFOS measurements according to the present disclosure which provides a method of measuring to inform about the effects of earthquake ground motions even in the absence of an earthquake detection scheme.

This is true in the use of the method generally as well as a use of the method in a specific case of a singular earthquake or earthquake sequency. For example, to make explicit what is meant by the general use case, consider a building owner or insurer of a building property in an earthquake-prone region of New Zealand. Said persons may be interested in a statistical distribution of peak ground acceleration (PGA) for their neighborhood or building because there is a frequent but low level of seismicity every year, no one event causing a major catastrophic amount of damage. In this case one could record and analyze DFOS measurements on a continuous basis and then compute the average PGA level for the segment of the fiber near the building of interest, or the average as well as a standard deviation or a different statistical measure, being sure to calculate this statistical view of the data over some time range that could extend historically up to many years. To make explicit what is meant by a specific use case of the method, consider how the same or a different building owner or an insurer may be interested to know the PGA value during one damaging earthquake mainshock, or during the mainshock and all subsequent aftershocks in a single mainshock/aftershock earthquake sequence. All measurements of PGA can be obtained from DFOS. And it is evident from this description, that the measurement of PGA being calculated could be conducted on a continuous basis (every minute, e.g.), and therefore both the general use case and the particular single earthquake use cases could be satisfied.

In embodiments, to estimate acceleration (A) using DFOS data, strain from DFOS at multiple positions in the fiber array are recorded. In embodiments, the multiple positions are all positions in the fiber array. PGA can be found by the relationships shown below in Equation 1:

$$A = - u \frac{\partial ε}{\partial t} \qquad [ Equation 1. ]$$

In this equation, u is a measure of the apparent velocity of the ground (subsurface media) in the horizontal direction along the fiber-optic cable and A is the acceleration (e.g., in units of m/s²).

DFOS data can be sampled uniformly in distance and time. In embodiments, the DFOS data are sample at approximately 1-10 m in space and at a fine time increment of 100-1000 samples per second. As a result, it is possible to use a 2-D Fourier Transform (FFT2) to convert any particular seismic phase from the arriving earthquake into a quantity that enables computation of acceleration. Thus, the previous equation can be rewritten as

$$A = - \frac{\partial }{\partial t} ( u ε ) \qquad [ Equation 2. ]$$

where ε represents the strain values recorded by the DFOS method. The strain values are digitized recordings sampled in time t at a sampling rate set by the analog to digital converter typically in the range of 100-2000 Hz. Every segment or gauge length of the fiber optic cable acts as an independent sensor, and hence the strain field is also sampled along the fiber optic cable in space x at a spatial sampling rate determined by the choice of this gauge length. A common gauge length is 10 meters. The gauge length can be predetermined in hardware, predetermined in software, or the raw optical phase data can be stored to enable a post-processing of different gauge lengths.
And then applying the approach above,

$$E ( ω , k ) = FFT 2 \{ ε ( t , x ) \} \qquad [ Equation 3. ]$$

$$u ε = FFT {2}^{- 1} \{ E * ω / k \} \qquad [ Equation 4. ]$$

$$A = - \frac{\partial }{\partial t} ( FFT {2}^{- 1} \{ E * ω / k \} ) \qquad [ Equation 5. ]$$

where ε represents the strain values recorded by the DFOS method, a quantity that depends both on x, the DFOS channel coordinate in space, and t, the time sample of the recording; E is the result of applying a two-dimensional Fourier Transform to ε, where E then has transformed frequency components ω and k, representing the temporal frequency and spatial frequency, respectively.

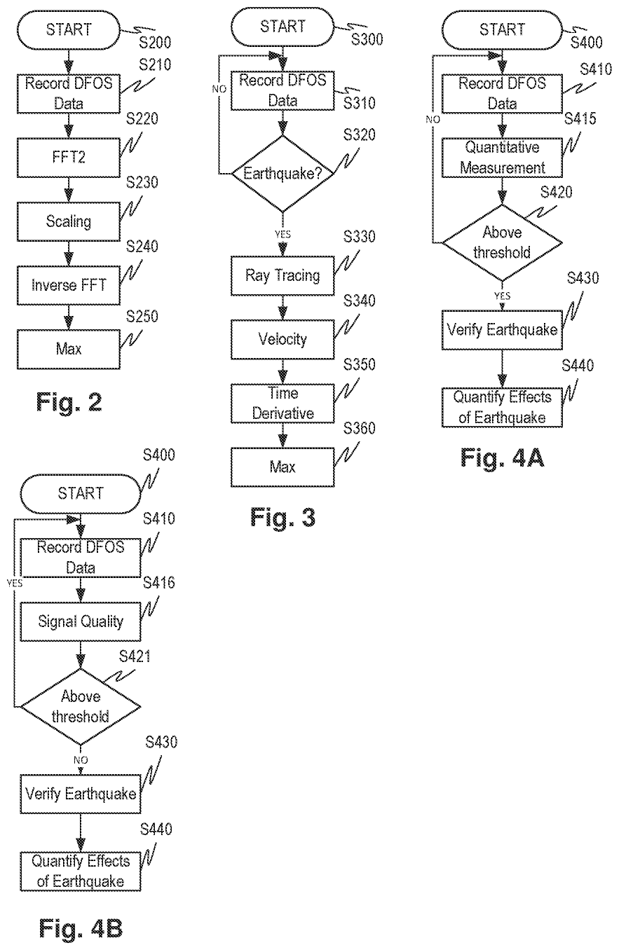

FIG. 2 illustrates a non-limiting example of a method of calculating peak ground acceleration according to embodiments of the disclosure. At S200, the process begins. DFOS data are recorded and stored at S210. The DFOS data includes strain data, which can also include strain amplitudes. Then, at S220 a two-dimensional Fourier Transform is applied which converts the strain data into the complex Fourier coefficients. Next, at S230, the Fourier coefficients are multiplied by the quantity ω/k which has an effect of scaling the original data by the apparent velocity as in Equation 4. Then, at S240, the data are transformed back to the space-time domain using a two-dimensional inverse Fourier transform and a time-derivative is applied to the data, as well as multiplying by −1 (negation), resulting in a dataset that has the units of acceleration A as in Equation 5. The maximum value of A at each channel is picked at S250 and is considered the peak ground acceleration for that position in the optical fiber.

In other embodiments, an alternative method of calculating peak ground acceleration is described. The alternative method employs a regional seismic velocity model that is used to estimate u through ray-tracing by using the approximate location of the earthquake source (latitude, longitude, depth to within 5 km depending on radial distance from the DFOS measurement position), and an estimate of the shear wave velocity (Vₛ) in the region of the fiber. The approximate location of the earthquake can be obtained from seismographs or other non-DFOS sensors, while DFOS sensing is used to quantify the effects of the earthquake on areas of interest and specific objects (such as buildings, bridges, roads) in the areas of interest. The value of Vₛ is known from geotechnical surveying, or from soil sampling, or from photogrammetry, or from aerial imagery, or through obtaining this information from geological map or other archive of geological information. In these embodiments, representative angles (θ) that the seismic waves make with the horizontal surface in the region of the DFOS array computed during ray-tracing are stored. Using these representative angles, for example, u is estimated using the equation below:

u=Vₛ*Cos(θ) [Equation 6.]

Then, acceleration values are computed using this relationship. This relationship is then used to compute the acceleration values as in Equation 1.

FIG. 3 illustrates a non-limiting example of a method of calculating peak ground acceleration based on a regional seismic velocity model. The process begins at S300. DFOS data may be recorded continuously and stored at S310. In embodiments, the data are recorded in a circular buffer with new data overwriting old data. This allows the analysis of relevant data while reducing storage requirements. An occurrence of an earthquake is detected at S320. As noted above, this detection can be through non-DFOS measurements, such as from measurements made by seismographs. This detection triggers the analysis DFOS data that has been recorded at S310.

Next, at S330 the seismic ray paths are ray-traced. This involves inputs of the earthquake hypocenter and regional geological information, which can for example be loaded from an external archive of this information such as is made available publicly by the U.S. Geological Survey (USGS). Ray tracing is an employment of Snell's Law, or the way that seismic waves refract as they pass from one material layer into the next material layer, depending on the angle of incidence with respect to the plane of the layer interface. The result of ray tracing is an estimate of the angle of incidence θ at the surface wherever the DFOS fiber channel of interest resides.

Then, at S340, the value of θ, obtained in S330, is used along with the shear wave velocity Vₛ of the subsurface around the DFOS fiber channel to compute u, as in Equation 6. In embodiments, the subsurface around the DFOS fiber is within 5 m, 10 m, 100 m, or 500 m of the DFOS fiber.

Finally, at S350, a time-derivative is applied to the recorded DFOS measurement values of strain, and then the value—u is multiplied in to obtain a dataset in units of acceleration A. The maximum value of A at each channel is considered the peak ground acceleration for that position in the optical fiber at selected at S360.

If a hospital or other critical infrastructure such as a bridge or a tunnel recorded strong shaking at a particular frequency known to excite building motions, additional safety protocols such as de-energizing of electricity, automatic gas shutoff valves, and elevator door opening can take place. This may be achieved on a building by building and address by address basis wherever the fiber used for DFOS exists.

Referring to FIG. 4A, a non-limiting example of a method of detecting and quantifying the effects of an earthquake based on degradation of fiber optic signal strength is illustrated. At S410, DFOS data are recorded and stored. The stored data are then analyzed at S415 using the quantitative measurement of the signal amplitude within a passband of the earthquake's dominant frequency range, 0.5-150 Hz for local earthquakes or 0.005-5 Hz for regional and teleseismic earthquakes. The result of this analysis could be an estimate of the expected amplitude at some distance of propagation beyond the region measured based on an understanding of the radiation of surface waves being like an inverse square law. In some embodiments, a general or specific attenuation model is employed, such as the one proposed by Anderson and Hart, 1978 that describes the extrinsic and intrinsic attenuative effects of the layered earth, in order to forecast the expected level of ground motion at a given location or city using the DFOS amplitude measurements.

If the quantitative measurement is above a predetermined threshold at S420, an earthquake occurrence is presumed. Otherwise, the process loops back. The signal amplitude degradation can be caused by other physical effects than an earthquake, such as vehicular traffic, construction, excavation, and other noise or energy added near the optical fiber(s) whose data is being recorded for DFOS. Thus, at S430 a verification of the occurrence of an earthquake is performed. This can include querying one or more computer systems that store seismic data to determine whether an earthquake had been detected by other sensors.

If an earthquake is confirmed at S430, the process continues at S440 where the effects of the earthquake are quantified for a particular location, such as a building or a bridge within sensing distance of the optical fiber(s). The quantification of the effects can follow the process illustrated in FIG. 2 and described above. More specifically, the process already includes recorded DFOS data, and the processing can continue at S220.

In other embodiments, even if dedicated DFOS fiber is not located near a location of interest, such as a hospital in the above example, the measurement and calculation of ground motion can be made based on other existing fiber communication infrastructure. Referring now to FIG. 4B, the steps are identical to those of FIG. 4A, except for the differences highlighted below.

In an embodiment, communication fibers without dedicated DFOS interrogator units are configured to continuously monitor the quality of the signals that are sent and received through the fibers (e.g., in terms of signal to noise ratio or a measure of scattering). This process is identical to that of FIG. 4A, except at S416 an assessment of signal quality is made. This assessment can be continuous, and may include the measurement of a signal to noise ratio of optical signals received and recorded by the DFOS system 100. The quality measurement (e.g., SNR) is compared to a threshold value at S421. When the quality drops to some predefined level, it is assumed that a physical change to the fiber has occurred, such as due to the seismic energy of an earthquake, and data that is useable for DFOS is recorded into a storage device. The recording can take place before and after the signal quality detection. In embodiments, a smaller amount of data is stored at S410 before a signal quality drop is detected. After the signal quality drop detection, a larger quantity of data is stored for analysis. This makes it possible to perform analysis of the recorded data if an earthquake did, in fact, cause the drop in signal quality (as opposed to e.g., road construction or other event), while the local storage capacity remains small and inexpensive enough such that many if not all fiber optic communication devices can perform this data collection. If the drop in quality is caused by an earthquake, the data stored by the fiber optic communication equipment is analyzed to determine quantitative measures of ground motion along the communication fiber.

In embodiments, a spatial resolution of 100 m is achievable such that it is possible to accurately calculate ground motion for a location of interest within 100 m of a fiber cable. Beyond this distance, soil conditions may vary to the degree that fiber measurement accuracy is reduced. The density of DFOS ground shaking measurements can be used to plan for safe places in cities which experience minimum ground shaking during earthquakes. Thus, a database of ground motion calculations is created to store output of DFOS ground shaking measurements indexed by location, making it possible to identify certain locations that do not experience dangerous ground motion (whether due to natural ground characteristics or particular man-made mitigation measures).

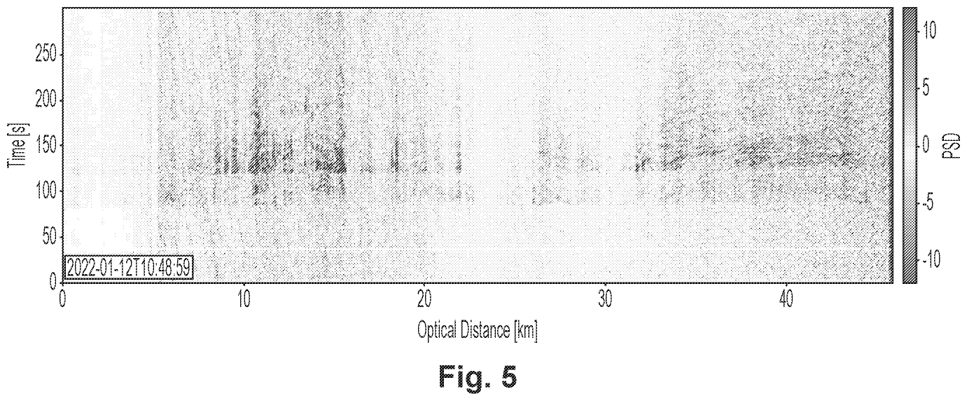

Referring now to FIG. 5, the plot illustrated in the figure represents an earthquake record section from a DFOS recording performed according to embodiments of the disclosed subject matter. Dark color indicates strong ground motion. The white line is the origin time at which the fault motion occurred, generating the seismic waves. Pulses of seismic energy are visible after some time at the DFOS channels, represented along the Optical Distance [km] of the x-axis. —the P-wave and the S-wave. The first arriving energy is the P-wave at about Time=80 seconds. The second pulse of energy about 35-40 seconds later at Time=120 s is the S-wave or surface wave. There is curvature to these arrivals due to the source-receiver geometry. There is also a high degree of amplitude variability. The channels around 5-16 km Optical Distance register stronger ground motions than the channels immediately before or after. This is a result of the ground amplification and is an effect captured by measurements of peak ground acceleration. This is valuable information to city planners, building owners, and geotechnical engineers, whose jobs involve designing or building to meet the expected hazards posed by peak ground acceleration levels in their area, or establishing the building codes based on these hazards.

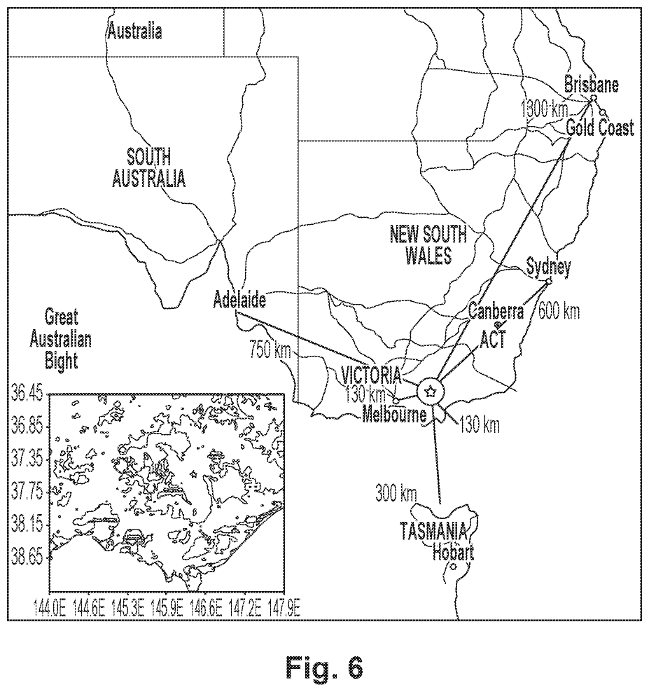

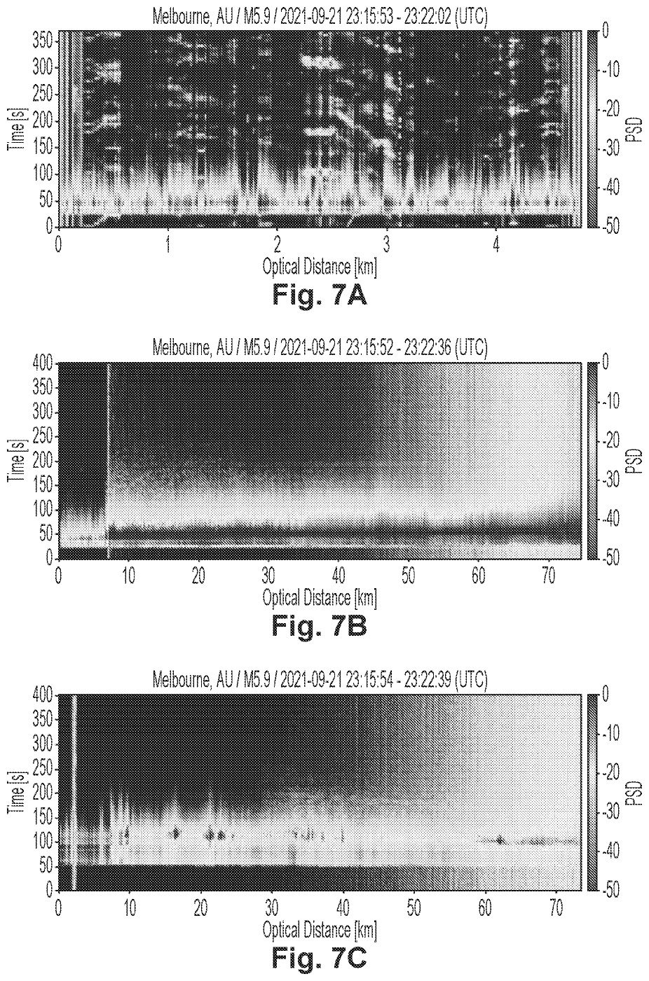

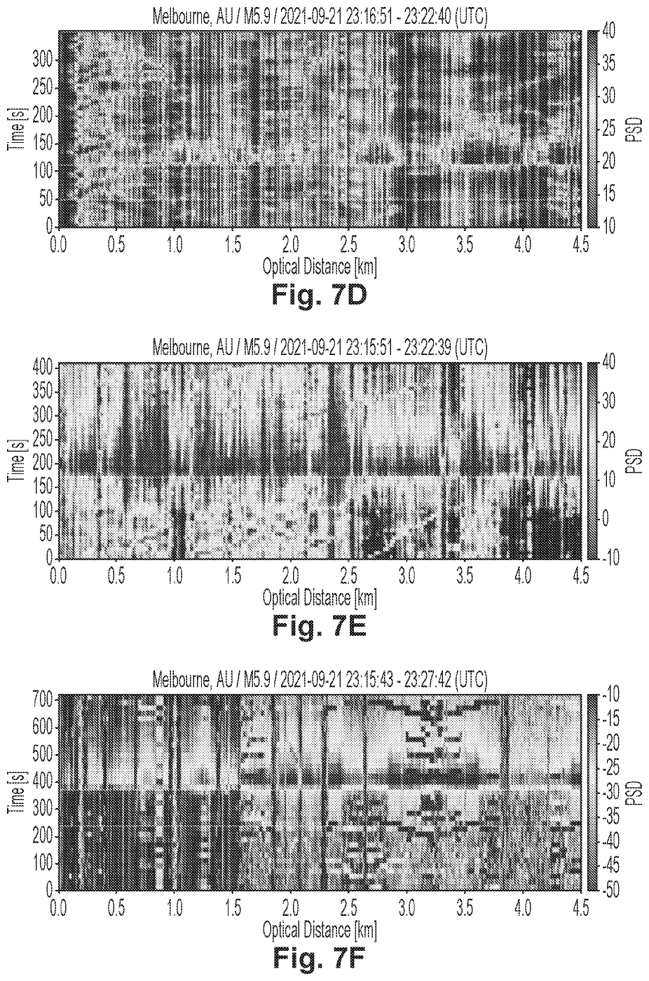

FIG. 6 illustrates exemplary regional coverage at a number of azimuths and distances around the M5.9 Melbourne, Australia earthquake that occurred on Sep. 21, 2021. Each of the positions located at an offset labeled here were recorded DFOS data during this time, and their data are shown in FIGS. 7A-F. This earthquake occurred about 130 km ENE of downtown Melbourne.

FIGS. 7A-F illustrate measurements of DFOS data from the 2021 M5.9 Melbourne, Australia earthquake. The vertical axis on the left represents time in seconds while the horizontal axis represents optical distance in kilometers. The scale on the right of each figure represents power spectral density corresponding to the grayscale shading of each figure. The high amplitude arriving energy spreads from one side of the array to the next. There are also very clear differences between segments of the fiber array. In FIG. 7A, the plot illustrated in the figure represents an earthquake record section from a DFOS recording performed according to embodiments of the disclosed subject matter in Melbourne, Australia. In FIG. 7B, the plot illustrated in the figure represents an earthquake record section from a DFOS recording performed according to embodiments of the disclosed subject matter offshore Victoria, Australia. In FIG. 7C, the plot illustrated in the figure represents an earthquake record section from a DFOS recording performed according to embodiments of the disclosed subject matter in a different region offshore Australia. In FIG. 7D, the plot illustrated in the figure represents an earthquake record section from a DFOS recording performed according to embodiments of the disclosed subject matter in a different region of Adelaide, Australia. FIG. 7E, the plot illustrated in the figure represents an earthquake record section from a DFOS recording performed according to embodiments of the disclosed subject matter in a different region of Sydney, Australia. In FIG. 7F, the plot illustrated in the figure represents an earthquake record section from a DFOS recording performed according to embodiments of the disclosed subject matter in a different region of Sydney, Australia. In each of FIG. 7A-FIG. 7F the dark horizontal signal feature arriving some time around Time=20 seconds up to Time=380 seconds is the seismic energy from the earthquake.

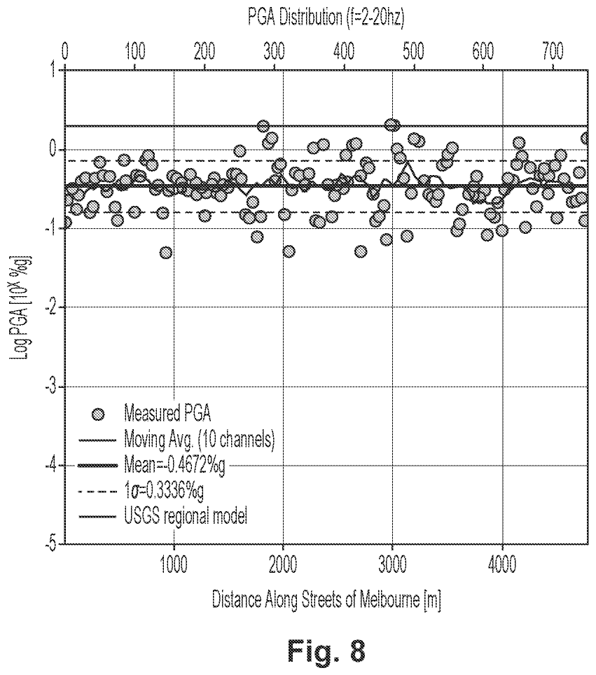

FIG. 8 illustrates a calculated result for a downtown Melbourne fiber recording of the 2021 M5.9 Melbourne, Australia earthquake. Every independent DFOS sensor records a unique seismogram, which is converted from raw strain units into acceleration units, and the peak sample is selected and plotted within the range shown. This allows calculating peak ground acceleration to the fine granularity of an address, which is referred to as PGA by address.

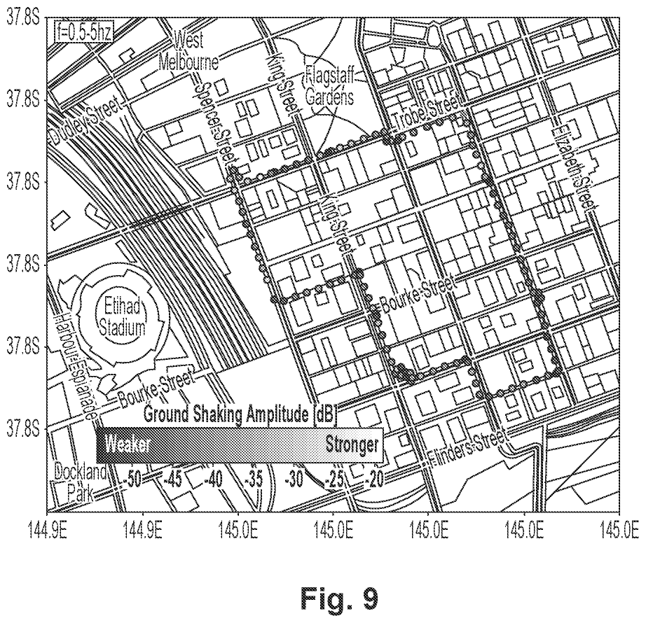

PGA by address results can be aggregated and overlayed on a map of an area of interest. Referring to FIG. 9, an example of a graphical earthquake report that includes a map of downtown Melbourne is featured with overlayed PGA by address values (with relative amplitude represented by grayscale shading with darker representing lower amplitude and lighter representing greater amplitude).

In embodiments, DFOS measurements during shaking are used to provide information about the inside of the building on a floor by floor basis using fiber optic cables running through the building. A modern building often includes fiber optic cables for communication purposes. These cables experience deformation that is caused by the seismic shaking of the structure during an earthquake. A single-port or multi-port DFOS instrument may be provided at one end of a single or many fiber optic cable(s) running throughout the building and it may record DFOS data continuously, or in a rolling buffer that is processed after an earthquake is detected. Analyzing the DFOS data from the building allows specific quantification of how individual sub-parts of the building (e.g., exterior shell, support columns, floor joists, ceiling joists, etc.) have been affected by the earthquake. For example, if the lower floors drift less than the upper floors, an assessment of relative floor drift magnitude could be computed using this type of DFOS data. Alternatively, by recording DFOS data from fiber running in the vertical direction and one horizontal direction, one could compute the horizontal-to-vertical deformation time series. By recording multiple components in a grid, one could compute the rotation of the structure through the computation of the spatial derivative of the strain in each component of recording. In embodiments, specific peak acceleration and/or displacement of one or more of these sub-parts is calculated based on DFOS data, and can then be compared the allowable thresholds (such as those provided by architects or building engineers.)

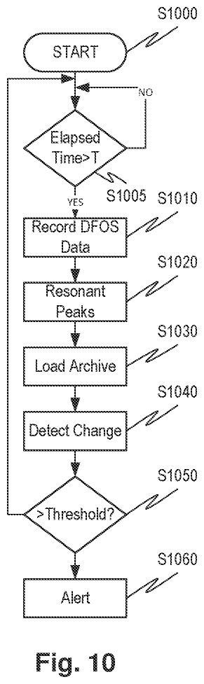

FIG. 10 illustrates a non-limiting example of a process of self-assessment of infrastructure, such as a building or a bridge, based on effects of an earthquake occurrence. In an embodiment, an automated building self-assessment is executed by a DFOS system. The process begins at S1000. As noted above, the DFOS system may be connected to fiber optic cables that run through the building, and may continuously record and analyze DFOS data, and calculate building component displacement and/or acceleration. The process can be executed on a regular schedule, such as every 10 minutes, which is represented as T in S1005. In embodiments, T is 1 hour, 12 hours, or 24 hours. In embodiments, the process runs continuously, meaning from a time of 0 seconds and until the T period passes, at which point the process continues at S1010.

At S1010, DFOS data are recorded and stored. It will be understood that the data that is recorded can represent the time period T, or a different duration of time. At S1020 resonant peaks of the structure of interest (e.g., building or bridge) are computed based on the DFOS data obtained in S1010. Historical values of resonant peaks are stored in a data storage. These values may include previously calculated values, or may be engineering parameters which are calculated based on the structure's design from finite element model simulation of the structure, or a generalized structural design. AT S1030 the archived values are retrieved from the data storage, and compared to the DFOS based values at S1040. The output of S1040 can be a difference value between the calculated value(s) and the archived value(s). The difference value(s) is/are compared to a threshold value at S1050. The threshold value may be an engineering parameter calculated based on finite element simulation of the structure, or the value may be established by safety regulations. In embodiments, the threshold value is adaptive and decreases based on historical measurements. This accounts for possible accumulation of structural effects on the structure, which can be considered cumulative. In embodiments, the system includes allowable thresholds of acceleration and/or displacement of the various sub-components, and may compare the calculated values to the thresholds, and then generate alerts at S1060 if one or more of the thresholds are exceeded. It will be appreciated that this allows for buildings to self-asses at least the initial damage that may be caused by an earthquake, and to quickly identify which building(s) need to be further examined by structural engineers to ensure building safety. The alert may be transmitted through a wired or wireless network to one or more designated recipients. In embodiments, the one or more designated recipients are occupants of a building if the building is the structure under monitoring.

After the shaking, DFOS measurements can be used to provide post-earthquake alerts about structural integrity of buildings and infrastructure. If the measured shaking exceeded a building or bridge's safety threshold, for example, then the building or piece of infrastructure may be automatically red-tagged so no one could re-enter/use it unsafety. The natural eigenmode resonances (frequency peaks of vibration or torsion of structure) can be measured and compared to the resonance before the earthquake. This information can be used to provide an alert about building damage.

Secondary hazards often follow in quick succession behind damaging ground shaking as a result of the physical surface processes generated by the earthquake. In embodiments, DFOS measurements about soil shaking are used to prompt liquefaction surveying, or hone the scale of liquification surveys in a targeted and a strategic manner to improve the use of resources.

Further embodiments of the disclosed subject matter are as follows. According to a first further embodiment, there is provided a method of determining a peak ground acceleration, the method including: providing a DFOS instrument connected to at least one optical fiber; recording DFOS data with the DFOS instrument, wherein the DFOS data includes strain data along the at least one optical fiber; converting the strain data into complex Fourier coefficients; scaling the complex Fourier coefficients; applying an inverse transform to the scaled Fourier coefficients; and selecting a maximum value from an output of the inverse transform to identify the peak ground acceleration for a position along the at least one optical fiber. According to a second further embodiment, there is provided the method of the first further embodiment, wherein the converting the strain data into complex Fourier coefficients includes applying a two-dimensional Fourier transform to the strain data. According to a third further embodiment, there is provided the method of the first further embodiment, wherein the applying the inverse transform includes applying a two-dimensional inverse Fourier transform to the scaled Fourier coefficients.

According to a fourth further embodiment, there is provided a method of determining a peak ground acceleration based on a regional seismic velocity model, the method including: providing a DFOS instrument connected to at least one optical fiber; recording DFOS data with the DFOS instrument, wherein the DFOS data includes strain data along the at least one optical fiber; detecting an occurrence of an earthquake; ray tracing seismic paths from a location of the earthquake to the optical fiber to determine an angle of incidence of seismic energy on a surface of ground where the optical fiber is located; calculating a measure of apparent velocity of ground based on the determined angle of incidence and a shear velocity of subsurface around the optical fiber; applying a time derivative to the calculated measure of apparent velocity to obtain a measure of ground acceleration; and selecting a maximum value from an output of the applying to identify the peak ground acceleration for a position along the at least one optical fiber. According to a fifth further embodiment, there is provided the method of the fourth further embodiment, wherein the apparent velocity of the ground is in in a horizontal direction. According to a sixth further embodiment, there is provided the method of the fourth further embodiment, wherein the detecting the occurrence of the earthquake is not based on DFOS data.

According to a seventh further embodiment, there is provided a method for determining characteristics of ground motion caused by an earthquake, the method including: recording DFOS data with a DFOS instrument, wherein the DFOS data includes strain data along at least one optical fiber; analyzing the recorded DFOS data to obtain a quantitative measurement of signal amplitude of the DFOS data; comparing the quantitative measurement of the signal amplitude to a predetermined threshold; preliminarily determining that an earthquake has occurred when the quantitative measurement is above the predetermined threshold; and quantifying effects of the earthquake. According to an eighth further embodiment, there is provided the method of the seventh further embodiment, further comprising verifying that an earthquake has occurred after the preliminary determining and before the quantifying. According to a ninth further embodiment, there is provided the method of the eighth further embodiment, wherein the analyzing the recorded DFOS data includes measuring a signal amplitude within a passband of a dominant frequency of the earthquake. According to a tenth further embodiment, there is provided the method of the ninth further embodiment, wherein the dominant frequency is in a range of 0.5 to 156 Hz for local earthquakes. According to an eleventh further embodiment, there is provided the method of the ninth further embodiment, wherein the dominant frequency is in a range of 0.005 to 5 Hz for regional and teleseismic earthquakes. According to a twelfth further embodiment, there is provided the method of the ninth further embodiment, wherein the verifying is based on non-DFOS measurements. According to a thirteenth further embodiment, there is provided the method of the ninth further embodiment, wherein the verifying is based on analysis of the recorded DFOS data. According to a fourteenth further embodiment, there is provided the method of the ninth further embodiment, wherein the quantifying includes determining peak ground acceleration of ground near the at least one optical fiber. According to a fifteenth further embodiment, there is provided the method of the fourteenth further embodiment, wherein the determining the peak ground acceleration includes converting strain data in the DFOS data into complex Fourier coefficients; scaling the complex Fourier coefficients; applying an inverse transform to the scaled Fourier coefficients; and selecting a maximum value from an output of the inverse transform to identify the peak ground acceleration for a position along the at least one optical fiber. According to a sixteenth further embodiment, there is provided the method of the fifteenth further embodiment, wherein the converting the strain data into complex Fourier coefficients includes applying a two-dimensional Fourier transform to the strain data. According to a seventeenth further embodiment, there is provided the method of the fifteenth further embodiment, wherein the applying the inverse transform includes applying a two-dimensional inverse Fourier transform to the scaled Fourier coefficients.

According to an eighteenth further embodiment, there is provided a method of determining characteristics of ground motion caused by an earthquake, the method including: recording DFOS data with a DFOS instrument, wherein the DFOS data includes strain data along at least one optical fiber; measuring signal quality of the DFOS data; comparing the measured signal quality of the DFOS data to a predetermined threshold; preliminarily determining that an earthquake has occurred when the measured signal quality is below the predetermined threshold; and quantifying effects of the earthquake. According to a nineteenth further embodiment, there is provided the method of the eighteenth further embodiment, further including verifying that an earthquake has occurred after the preliminary determining and before the quantifying. According to a twentieth further embodiment, there is provided the method of the nineteenth further embodiment, wherein the measuring the signal quality includes determining a signal to noise ratio of the DFOS data. According to a twenty-first further embodiment, there is provided the method of the nineteenth further embodiment, wherein the measuring the signal quality is applied to the recorded DFOS data. According to a twenty-second further embodiment, there is provided the method of the nineteenth further embodiment, wherein the measuring the signal quality is applied to the DFOS data concurrently with the recording of the DFOS data. According to a twenty-third further embodiment, there is provided the method of the nineteenth further embodiment, wherein the quantifying includes determining peak ground acceleration of ground near the at least one optical fiber. According to a twenty-fourth further embodiment, there is provided the method of the twenty-third further embodiment, wherein the determining the peak ground acceleration includes converting strain data in the DFOS data into complex Fourier coefficients; scaling the complex Fourier coefficients; applying an inverse transform to the scaled Fourier coefficients; and selecting a maximum value from an output of the inverse transform to identify the peak ground acceleration for a position along the at least one optical fiber. According to a twenty-fifth further embodiment, there is provided the method of the twenty-fourth further embodiment, wherein the converting the strain data into complex Fourier coefficients includes applying a two-dimensional Fourier transform to the strain data. According to a twenty-sixth further embodiment, there is provided the method of the twenty-fifth further embodiment, wherein the applying the inverse transform includes applying a two-dimensional inverse Fourier transform to the scaled Fourier coefficients.

According to a twenty-seventh further embodiment, there is provided a method of assessing effects of ground motion on a structure, the method including recording DFOS data with a DFOS instrument, wherein the DFOS data includes strain data along at least one optical fiber; computing resonant peaks of the structure based on the DFOS data; storing the computed resonant peaks in a storage device archiving resonant peak values associated with the structure; retrieving archived values of resonant peaks from the storage device; detecting a change between the retrieved archived values and the computed resonant peaks based on the DFOS data, the change represented by a change value; comparing the change value to a threshold value; and generating an alert when the detected change is above the threshold value. According to a twenty-eighth further embodiment, there is provided the method of the twenty-seventh further embodiment, further comprising installing the at least one optical fiber near the structure. According to a twenty-ninth further embodiment, there is provided the method of the twenty-eighth further embodiment, wherein the at least one optical fiber is in or under the structure. According to a thirtieth further embodiment, there is provided the method of the twenty-seventh further embodiment, wherein the method is repeated on a schedule. According to a thirty-first further embodiment, there is provided the method of the thirtieth further embodiment, wherein a period of the schedule is between 5 minutes and 48 hours. According to a thirty-second further embodiment, there is provided the method of the thirty-first further embodiment, wherein the period of the schedule is 10 minutes, 60 minutes, 12 hours, or 24 hours. According to a thirty-third further embodiment, there is provided the method of the thirtieth further embodiment, wherein a period of the schedule is adaptive and decreases in duration in response to a result of the comparing. According to a thirty-fourth further embodiment, there is provided the method of the twenty-seventh further embodiment, wherein the structure is one of a building, a bridge, and a tower. According to a thirty-fifth further embodiment, there is provided the method of the twenty-seventh further embodiment, wherein engineering design parameters based on a design of the structure are stored in the storage device. According to a thirty-sixth further embodiment, there is provided the method of the thirty-fifth further embodiment, wherein the storage device stores multiple resonant peak values associated with the structure, each of the values associated with at least one of a time stamp and a time duration. According to a thirty-seventh further embodiment, there is provided the method of the thirty-sixth further embodiment, further comprising: accumulating the detected change values over time to identify a cumulative change value that represents change between most recently calculated resonant peaks and oldest resonant peak values stored in the storage device. According to a thirty-eighth further embodiment, there is provided the method of any of the twenty-seventh through thirty-seventh further embodiments, wherein the ground motion is caused by an earthquake. According to a thirty-ninth further embodiment, there is provided the method of the twenty-seventh further embodiment, wherein the threshold value is adaptive and decreases over time. According to a fortieth further embodiment, there is provided the method of the twenty-seventh further embodiment, wherein the generating the alert includes transmitting a signal over a wired or wireless network. According to a forty-first further embodiment, there is provided the method of the twenty-seventh further embodiment, wherein the generating the alert includes outputting a human-audible message inside of the structure. According to a forty-second further embodiment, there is provided the method of the forty-first further embodiment, wherein the human-audible message includes information about possible damage to the structure.

According to a forty-third further embodiment, there is provided a method of generating an earthquake warning at a first location that is remote from a second location that is an epicenter of an earthquake, the method including: measuring DFOS data at first location in an optical fiber that extends from the first location to an area surrounding the second location; computing from the DFOS data an indication that an earthquake has occurred at the second location; and generating an alert at the first location that the earthquake has occurred. According to a forty-fourth further embodiment, there is provided the method of the forty-third further embodiment, wherein the first location is outside of a populated area, and the second location is in a populated area. According to a forty-fifth further embodiment, there is provided the method of the forty-fourth further embodiment, wherein the first location is offshore. According to a forty-sixth further embodiment, there is provided the method of the forty-fourth further embodiment, wherein the first location is in a rural area. According to a forty-seventh further embodiment, there is provided the method of the forty-fourth further embodiment, wherein the second location is in a city. According to a forty-eighth further embodiment, there is provided the method of the forty-third further embodiment, wherein the generating of the alert takes place before P-waves and/or damaging ground motions from the earthquake arrive at the first location. According to a forty-ninth further embodiment, there is provided the method of the forty-third further embodiment, wherein the measuring the DFOS data includes transmitting light from a DFOS device into the optical fiber and receiving refracted or reflected light from the optical fiber. According to a fiftieth further embodiment, there is provided the method of the forty-third further embodiment, wherein the measuring the DFOS data includes transmitting light from an optical communication device into the optical fiber and receiving refracted light from the optical fiber. According to a fifty-first further embodiment, there is provided the method of the forty-third further embodiment, wherein the measuring the DFOS data includes measuring strain. According to a fifty-second further embodiment, there is provided the method of the forty-third further embodiment, wherein the measuring the DFOS data includes measuring ground motion. According to a fifty-third further embodiment, there is provided the method of the forty-third further embodiment, wherein the computing includes calculating a magnitude of the earthquake. According to a fifty-fourth further embodiment, there is provided the method of the forty-third further embodiment, wherein the computing includes calculating a geographical position of the second location. According to a fifty-fifth further embodiment, there is provided the method of the forty-third further embodiment, wherein the computing includes calculating a peak ground acceleration of the second location. According to a fifty-sixth further embodiment, there is provided the method of the forty-third further embodiment, wherein the computing includes calculating a peak ground acceleration of the first location. According to a fifty-seventh further embodiment, there is provided the method of the forty-third further embodiment, wherein the computing includes calculating a peak ground acceleration of a location within a predetermined distance of the optical fiber. According to a fifty-eighth further embodiment, there is provided the method of the fifty-seventh further embodiment, wherein the predetermined distance is between 50 meters and 500 meters. According to a fifty-ninth further embodiment, there is provided the method of the fifth-eighth further embodiment, wherein the predetermined distance is 100 meters. According to a sixtieth further embodiment, there is provided the method of any of the forty-third through fifty-ninth further embodiments, wherein measuring the DFOS data includes selecting an unlit or unused piece of optical spectrum from an otherwise lit optical fiber, or a polarization eigenmode from an otherwise lit optical fiber or an entire dark fiber from an established and dedicated telecommunications network.

According to a sixty-first further embodiment, there is provided a method of quantifying effects of an earthquake having an epicenter at a first location, the method including: measuring DFOS data with a DFOS system at a second location that is displaced from the first location during the earthquake; and using the measured DFOS data, calculating at least one of peak ground acceleration, peak ground velocity, peak ground displacement, peak ground strain, peak ground strain-rate, peak spectral acceleration, and/or earthquake intensity. According to a sixty-second further embodiment, there is provided the method of the sixty-first further embodiment, further comprising: recording the measured DFOS data; receiving a notification that an earthquake has occurred; and responsive to the received notification, using the measured DFOS data that has been recorded, calculating at least one of earthquake magnitude, moment, strain, strain-rate, geodetic deformation, location, depth, focal mechanism, radiation pattern, moment tensor, finite fault region of slip, slip rate, and rupture velocity of the earthquake that has occurred. According to a sixty-third further embodiment, there is provided the method of the sixty-second further embodiment, further comprising: generating an alert from the DFOS system based on the calculating; and transmitting the generated alert to a receiver in a populated area. According to a sixty-fourth further embodiment, there is provided the method of the sixty-first further embodiment, wherein the measuring DFOS data includes transmitting and receiving DFOS signals on a singular telecommunication fiber that is used contemporaneously for DFOS earthquake sensing and for transmitting telecommunication traffic. According to a sixty-fifth further embodiment, there is provided the method of the sixty-first further embodiment, wherein the measuring the DFOS data takes place during the occurrence of the earthquake, and the calculating takes place after the occurrence of the earthquake. According to a sixty-sixth further embodiment, there is provided the method of the sixty-first further embodiment, wherein the measuring the DFOS data and the calculating takes place during the occurrence of the earthquake. According to a sixty-seventh further embodiment, there is provided the method of the sixty-first further embodiment, wherein the calculating represents physical effects at the second location. According to a sixty-eighth further embodiment, there is provided the method of the sixty-first further embodiment, wherein a DFOS device is located at the second location. According to a sixty-ninth further embodiment, there is provided the method of the sixty-first further embodiment, wherein the calculating represents physical effects at a third location that is located between the first location and the second location. According to a seventieth further embodiment, there is provided the method of the sixty-first further embodiment, wherein the measuring the DFOS data includes transmitting light from the DFOS system into an optical fiber and receiving refracted light from the optical fiber, and the calculating represents physical effects at a third location that is located within a predetermined distance of the optical fiber. According to a seventy-first further embodiment, there is provided the method of the sixty-first further embodiment, wherein the measuring the DFOS data includes transmitting light from the DFOS system into an optical fiber and receiving refracted light from the optical fiber. According to a seventy-second further embodiment, there is provided the method of the sixty-first further embodiment, wherein the measuring the DFOS data includes transmitting light from an optical communication device into an optical fiber and receiving refracted light from the optical fiber. According to a seventy-third further embodiment, there is provided the method of the seventieth further embodiment, wherein the predetermined distance is between 50 meters and 500 meters. According to a seventy-fourth further embodiment, there is provided the method of the seventy-third further embodiment, wherein the predetermined distance is 100 meters. According to a seventy-fifth further embodiment, there is provided the method of the sixty-seventh further embodiment, wherein the second location is a site of at least one of a building, a data center, a hospital, an airport, critical infrastructure, a road, a bridge, a tunnel, a home, a hotel, and other structure or built object that is affected by ground shaking. According to a seventy-sixth further embodiment, there is provided the method of any of the sixty-first through seventy-fifth further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network.

According to a seventy-seventh further embodiment, there is provided a method of quantifying effects of an earthquake, the method comprising: measuring DFOS data at least during the occurrence of the earthquake; and using the measured DFOS data, calculating at least one of a direction of ground motion during the occurrence of the earthquake and duration of the ground motion during the occurrence of the earthquake. According to a seventy-eighth further embodiment, there is provided the method of the seventy-seventh further embodiment, wherein the measuring the DFOS data includes transmitting light from a DFOS device into an optical fiber and receiving refracted light from the optical fiber. According to a seventy-ninth further embodiment, there is provided the method of the seventy-seventh further embodiment, wherein the measuring the DFOS data includes transmitting light from an optical communication device into an optical fiber and receiving refracted light from the optical fiber. According to an eightieth further embodiment, there is provided the method of any of the seventy-seventh through seventy-ninth further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network.

According to an eighty-first further embodiment, there is provided a method of analyzing effects of an earthquake on a building, the method comprising: measuring DFOS data at least during the occurrence of the earthquake; calculating eigenmode resonance values of the building from the measured DFOS data; and determining a quantity representing an intensity of the building shaking from the eigenmodes. According to an eighty-second further embodiment, there is provided the method of the eighty-first further embodiment, wherein the measuring the DFOS data includes transmitting light from a DFOS device into an optical fiber and receiving refracted light from the optical fiber, and the optical fiber extends within a predetermined distance away from the building or passes through the building. According to an eighty-third further embodiment, there is provided the method of the eighty-first further embodiment, wherein the measuring the DFOS data includes transmitting light from a DFOS device into an optical fiber and receiving refracted light from the optical fiber. According to an eighty-fourth further embodiment, there is provided the method of the eighty-first further embodiment, wherein the measuring the DFOS data includes transmitting light from an optical communication device into an optical fiber and receiving refracted light from the optical fiber. According to an eighty-fifth further embodiment, there is provided the method of the eighty-first further embodiment, wherein the measuring the DFOS data takes place during shaking caused by the earthquake. According to an eighty-sixth further embodiment, there is provided the method of the eighty-first further embodiment, wherein the calculating takes place during the shaking caused by the earthquake. According to an eighty-seventh further embodiment, there is provided the method of the eighty-fifth further embodiment, wherein the calculating takes place after the shaking caused by the earthquake ends. According to an eighty-eighth further embodiment, there is provided the method of the eighty-first further embodiment, wherein the determining includes comparing the eigenmodes of the building calculated after the occurrence of the earthquake to pre-earthquake eigenmodes. According to an eighty-ninth further embodiment, there is provided the method of the eighty-eighth further embodiment, further comprising: relating a change in the eigenmodes to a state change of structural health of the building. According to a ninetieth further embodiment, there is provided the method of any of the eighty-first through eighty-ninth further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network.

According to ninety-first further embodiment, there is provided a method of generating safety alerts for a structure in an aftermath of an earthquake, the method comprising: measuring DFOS data at least during an occurrence of an earthquake; calculating a safety score for the structure based on the measured DFOS data; and generating a safety alert based on the safety score. According to a ninety-second further embodiment, there is provided the method of the ninety-first further embodiment, wherein the safety score is based on a comparison of peak ground acceleration calculated from the measured DFOS data and a peak ground acceleration rating of the structure. According to a ninety-third further embodiment, there is provided the method of the ninety-first further embodiment, wherein the safety alert includes a representation of the calculated safety score. According to a ninety-fourth further embodiment, there is provided the method of the ninety-first further embodiment, wherein the safety alert is classified into a plurality of severity levels, and the generating is based on the severity level. According to a ninety-fifth further embodiment, there is provided the method of the ninety-fourth further embodiment, further comprising: transmitting the generated safety alert to a recipient selected based on the severity level. According to a ninety-sixth further embodiment, there is provided the method of the ninety-first further embodiment, wherein the safety alert indicates whether the structure is safe for entry by human occupants. According to a ninety-seventh further embodiment, there is provided the method of the ninety-first further embodiment, wherein the measuring the DFOS data includes transmitting light from a DFOS system into an optical fiber and receiving refracted light from the optical fiber. According to a ninety-eighth further embodiment, there is provided the method of the ninety-first further embodiment, wherein the measuring the DFOS data includes transmitting light from an optical communication device into an optical fiber and receiving refracted light from the optical fiber. According to a ninety-ninth further embodiment, there is provided the method of the ninety-eighth further embodiment, further comprising: storing the measured DFOS data in a storage device in response to a detection of a physical change in the optical fiber. According to a hundredth further embodiment, there is provided the method of any of the ninety-first through ninety-ninth further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network.

According to a hundred-first further embodiment, there is provided a method of detecting damage to a building, the method comprising: measuring DFOS data with an optical fiber in or near the building; calculating a physical quantity based on the measured DFOS representing at least one of building story drift, peak ground acceleration under or beside the building, peak ground acceleration of a component of the building itself, and liquefaction; comparing the calculated physical quantity to a specification of the building; and generating an alert indicating possible building damage based on the calculated physical quantity and the specification of the building. According to a hundred-second further embodiment, there is provided the method of the hundred-first further embodiment, wherein the measuring the DFOS data includes transmitting light from a DFOS system into an optical fiber and receiving refracted light from the optical fiber. According to a hundred-second further embodiment, there is provided the method of the hundred-first further embodiment, wherein the measuring the DFOS data includes transmitting light from an optical communication device into an optical fiber and receiving refracted light from the optical fiber. According to a hundred-fourth further embodiment, there is provided the method of any of the hundred-second through hundred-third further embodiments, wherein the optical fiber extends below the building. According to a hundred-fifth further embodiment, there is provided the method of any of the hundred-second through hundred-third further embodiments, wherein the optical fiber extends through the building. According to a hundred-sixth further embodiment, there is provided the method of the hundred-fifth further embodiment, wherein the optical fiber extends through multiple stories of the building. According to a hundred-seventh further embodiment, there is provided the method of the hundred-sixth further embodiment, wherein the optical fiber winds around a foundation of the building. According to an hundred-eighth further embodiment, there is provided the method of any of the hundred-first through hundred-seventh further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network.

According to an 109^{th} further embodiment, there is provided a method of detecting damage to infrastructure, the method comprising: measuring DFOS data with an optical fiber in or near the infrastructure; calculating a physical quantity based on the measured DFOS representing at least one of building story drift, peak ground acceleration under or beside the building, peak ground acceleration of a component of the infrastructure itself, and liquefaction; comparing the calculated physical quantity to a specification of the infrastructure; and generating an alert indicating possible infrastructure damage based on the calculated physical quantity and the specification of the infrastructure. According to a 110^{th} further embodiment, there is provided the method of the 109^{th} further embodiment, wherein the measuring the DFOS data includes transmitting light from a DFOS system into an optical fiber and receiving refracted light from the optical fiber. According to a 111^{th} further embodiment, there is provided the method of the 109^{th} further embodiment, wherein the measuring the DFOS data includes transmitting light from an optical communication device into an optical fiber and receiving refracted light from the optical fiber. According to a 112^{th} further embodiment, there is provided the method of the 110^{th} or the 111^{th} further embodiment, wherein the optical fiber extends below the infrastructure. According to a 113^{th} further embodiment, there is provided the method of the 110^{th} or the 111^{th} further embodiment, wherein the optical fiber extends through the infrastructure. According to a 114^{th} further embodiment, there is provided the method of the 113^{th} further embodiment, wherein the optical fiber extends through multiple horizontal levels of the infrastructure. According to a 115^{th} further embodiment, there is provided the method of the 113^{th} further embodiment, wherein the optical fiber winds around a foundation of the infrastructure. According to a 116^{th} further embodiment, there is provided the method of any one of the 109^{th} through the 115^{th} further embodiments, wherein the infrastructure includes at least one of a building, a bridge, a road, a monument, a street light, a construction site, a mine, a subterranean structure, a tunnel, a mass transit depot, an airport, a railway station, a factory, and a seaport. According to a 117^{th} further embodiment, there is provided the method of any one of the 109^{th} through the 116^{th} further embodiments, wherein measuring the DFOS data includes selecting an unlit or unused piece of optical spectrum from an otherwise lit optical fiber, or a polarization eigen mode from an otherwise lit optical fiber or an entire dark fiber from an established and dedicated telecommunications network. According to a 118^{th} further embodiment, there is provided a DFOS device, comprising: a light transmitter configured to transmit light into an optical fiber; a receiver configured to receive light from the optical fiber; and a controller configured to execute a method as defined in any of the 43^{rd} through 117^{th} further embodiments. According to a 119^{th} further embodiment, there is provided a system for processing earthquake data, comprising: one or more DFOS devices according to the 118^{th} further embodiment; and one or more optical fibers operatively connected to the one or more DFOS devices. According to a 120^{th} further embodiment, there is provided a method of detecting an occurrence of an earthquake, comprising: measuring DFOS data in an optical fiber located within a sensing distance of an epicenter of the earthquake; and analyzing the DFOS data to detect that the earthquake has occurred. According to a 121^{st} further embodiment, there is provided the method of the 120^{th} further embodiment, further comprising: connecting a DFOS device to the optical fiber, wherein the measuring the DFOS data includes transmitting light from the DFOS device into the optical fiber and receiving refracted light from the optical fiber. According to a 122^{nd} further embodiment, there is provided the method of the 120^{th} further embodiment, wherein the measuring the DFOS data includes transmitting light from an optical communication device into the optical fiber and receiving refracted light from the optical fiber. According to a 123^{rd} further embodiment, there is provided the method of the 120^{th} further embodiment, further comprising: computing a magnitude of the earthquake from the analyzing of the DFOS data. According to a 124^{th} further embodiment, there is provided the method of the 120^{th} further embodiment, wherein the measuring the DFOS data includes measuring strain. According to a 125^{th} further embodiment, there is provided the method of the 120^{th} further embodiment, wherein the measuring the DFOS data includes measuring ground motion. According to a 126^{th} further embodiment, there is provided the method of any one of the 120^{th} through the 125^{th} further embodiments, wherein measuring the DFOS data includes selecting an unlit or unused piece of optical spectrum from an otherwise lit optical fiber, or a polarization eigenmode from an otherwise lit optical fiber or an entire dark fiber from an established and dedicated telecommunications network.

According to a 127^{th} further embodiment, there is provided a method of analyzing effects of an earthquake by a DFOS system, the method comprising: capturing DFOS data by the DFOS system; storing the captured DFOS data; receiving a notification external from the DFOS system that the earthquake has occurred; and analyzing the stored DFOS data to quantify the effects of the earthquake. According to a 128^{th} further embodiment, there is provided the method of the 127^{th} further embodiment, wherein the capturing is continuous in time. According to a 129^{th} further embodiment, there is provided the method of any one of the 127^{th} through the 128^{th} further embodiments, wherein the storing includes overwriting previously stored DFOS data, and new DFOS data overwrites oldest DFOS data. According to a 130^{th} further embodiment, there is provided the method of any one of the 127^{th} through the 129^{th} further embodiments, wherein the capturing of the DFOS data includes emitting light into an optical fiber and receiving light from the optical fiber. According to a 131^{st} further embodiment, there is provided the method of any one of the 127^{th} through the 130^{th} further embodiments, wherein the receiving of the notification includes receiving a signal originating from a seismograph. According to a 132^{nd} further embodiment, there is provided the method of any one of the 127^{th} through the 131^{st} further embodiments, wherein the receiving of the notification includes receiving a signal from a wireless network. According to a 133^{rd} further embodiment, there is provided the method of any one of the 127^{th} through the 132^{nd} further embodiments, wherein the signal is a processed output of a geophone. According to a 134^{th} further embodiment, there is provided the method of any one of the 127^{th} through the 133^{rd} further embodiments, wherein the analyzing the stored DFOS data includes calculating peak ground acceleration. According to a 135^{th} further embodiment, there is provided the method of any one of the 127^{th} through the 133^{rd} further embodiments, wherein the analyzing the stored DFOS data includes measuring geodetic strain response in an area within sensing distance of the optical fiber.

According to a 136^{th} further embodiment, there is provided a method of determining peak ground acceleration at a first location, the method comprising: providing an optical fiber withing a first distance of the first location, the optical fiber extending in a single direction over a second distance; calculating an apparent velocity of ground in which the optical fiber is located in a horizontal direction based on DFOS data; and differentiating the apparent velocity in time to obtain acceleration. According to a 137^{th} further embodiment, there is provided the method of the 136^{th} further embodiment, wherein the first distance is less than 100 meter, and the second distance is greater than 100 meters.

According to a 138^{th} further embodiment, there is provided a method of visually representing effects of an earthquake on multiple distinct locations within a geographic area, the method comprising: providing at least one optical fiber within a sensing distance of the geographic area; calculating a peak ground acceleration value for each one of the multiple distinct locations based on DFOS data; and overlaying the calculated peak ground acceleration values on a map that represents the multiple locations. According to a 139^{th} further embodiment, there is provided the method of the 138^{th} further embodiment, wherein the calculating the peak ground acceleration value includes capturing DFOS data by a DFOS system from the at least one optical fiber; calculating an apparent velocity of ground in which the optical fiber is located in a horizontal direction based on the DFOS data; and differentiating the apparent velocity in time to obtain acceleration.

According to a 140^{th} further embodiment, there is provided a method of detecting an occurrence of an earthquake, comprising: measuring DFOS data in an optical fiber located within a sensing distance of an epicenter of the earthquake; and analyzing the DFOS data to detect that the earthquake has occurred. According to a 141^{st} further embodiment, there is provided the method of the 140^{th} further embodiment, further comprising: connecting a DFOS device to the optical fiber, wherein the measuring the DFOS data includes transmitting light from the DFOS device into the optical fiber and receiving refracted light from the optical fiber. According to a 142^{nd} further embodiment, there is provided the method of the 140^{th} further embodiment, wherein the measuring the DFOS data includes transmitting light from an optical communication device into the optical fiber and receiving refracted light from the optical fiber. According to a 143^{rd} further embodiment, there is provided the method of the 140^{th} further embodiment, further comprising: computing a magnitude of the earthquake from the analyzing of the DFOS data. According to a 144^{th} further embodiment, there is provided the method of the 140^{th} further embodiment, wherein the measuring the DFOS data includes measuring strain. According to a 145^{th} further embodiment, there is provided the method of the 140^{th} further embodiment, wherein the measuring the DFOS data includes measuring ground motion. According to a 146^{th} further embodiment, there is provided the method of any one of the 140^{th} through the 145^{th} further embodiments, wherein measuring the DFOS data includes selecting an unlit or unused piece of optical spectrum from an otherwise lit optical fiber, or a polarization eigenmode from an otherwise lit optical fiber or an entire dark fiber from an established and dedicated telecommunications network.

It is, thus, apparent that there are provided, in accordance with the present disclosure, distributed fiber-optic sensing systems, devices, and methods. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1-6. (canceled)

7. A method determining characteristics of ground motion caused by an earthquake, the method comprising:
recording DFOS data along at least one optical fiber with a DFOS instrument;
analyzing the recorded DFOS data to obtain a quantitative measurement of signal amplitude of the DFOS data;
comparing the quantitative measurement of the signal amplitude to a predetermined threshold;
preliminarily determining that an earthquake has occurred when the quantitative measurement is above the predetermined threshold; and
quantifying effects of the earthquake.

8. The method according to claim 7, further comprising verifying that an earthquake has occurred after the preliminary determining and before the quantifying.

9. The method according to claim 7, wherein the analyzing the recorded DFOS data includes measuring a signal amplitude within a passband of a dominant frequency of the earthquake.

10. The method according to claim 9, wherein the dominant frequency is in a range of 0.5 to 156 Hz for local earthquakes.

11. The method according to claim 9, wherein the dominant frequency is in a range of 0.005 to 5 Hz for regional and teleseismic earthquakes.

12. The method according to claim 8, wherein the verifying is based on non-DFOS measurements.

13. The method according to claim 8, wherein the verifying is based on analysis of the recorded DFOS data.

14. The method according to claim 7, wherein the DFOS data includes strain data and the quantifying includes determining peak ground acceleration of ground near the at least one optical fiber.

15. The method according to claim 14, wherein the determining the peak ground acceleration includes: converting strain data in the DFOS data into complex Fourier coefficients; scaling the complex Fourier coefficients; applying an inverse transform to the scaled Fourier coefficients; and selecting a maximum value from an output of the inverse transform to identify the peak ground acceleration for a position along the at least one optical fiber.

16. The method according to claim 15, wherein the converting the strain data into complex Fourier coefficients includes applying a two-dimensional Fourier transform to the strain data.

17. The method according to claim 15, wherein the applying the inverse transform includes applying a two-dimensional inverse Fourier transform to the scaled Fourier coefficients.

18. A method of determining characteristics of ground motion caused by an earthquake, the method comprising:
recording DFOS data along at least one optical fiber with a DFOS instrument; measuring signal quality of the DFOS data;
comparing the measured signal quality of the DFOS data to a predetermined threshold;
preliminarily determining that an earthquake has occurred when the measured signal quality is below the predetermined threshold; and
quantifying effects of the earthquake.

19. The method according to claim 18, further comprising verifying that an earthquake has occurred after the preliminary determining and before the quantifying.

20. The method according to claim 18, wherein the measuring the signal quality includes determining a signal to noise ratio of the DFOS data.

21. The method according to claim 18, wherein the measuring the signal quality is applied to the recorded DFOS data.

22. The method according to claim 18, wherein the measuring the signal quality is applied to the DFOS data concurrently with the recording of the DFOS data.

23. The method according to claim 18, wherein the DFOS data includes strain data and the quantifying includes determining peak ground acceleration of ground near the at least one optical fiber.

24. The method according to claim 23, wherein the determining the peak ground acceleration includes:
converting strain data in the DFOS data into complex Fourier coefficients;
scaling the complex Fourier coefficients; applying an inverse transform to the scaled Fourier coefficients; and
selecting a maximum value from an output of the inverse transform to identify the peak ground acceleration for a position along the at least one optical fiber.

25. The method according to claim 24, wherein the converting the strain data into complex Fourier coefficients includes applying a two-dimensional Fourier transform to the strain data.

26. The method according to claim 25, wherein the applying the inverse transform includes applying a two-dimensional inverse Fourier transform to the scaled Fourier coefficients.

27-96. (canceled)
